(19) United States
(12) Patent Application Publication
(10) Pub. No.: US 2006/0132846 A1
(43) Pub. Date: Jun. 22, 2006

(54) Host computer to multi-function machine faxing through direct access of modem

(75) Inventors: Larry J. Dicken, Lexington, KY (US); Duane E. Norris, Richmond, KY (US); Stephen R. Troyer, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/003,944

(22) Filed: Dec. 3, 2004

(51) Int. Cl. H04N 1/40

(52) U.S. Cl. 358/3.01

(57) ABSTRACT

A method and system of operating a multi-function imaging machine, includes the steps of: providing the multi-function imaging machine with a printer section, a fax section, a modem associated with the fax section, and a first processing means coupled with each of the printer section, the fax section and the modem; providing a computer coupled with the multi-function imaging machine, the computer including a second processing means coupled with the multi-function imaging machine; generating AT commands with the second processing means; transmitting the AT commands from the second processing means to the modem; connecting the modem with a remote modem; transmitting a query from the second processing means to the remote modem; and receiving a response to the query from the remote modem at the second processing means.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND OF THE INVENTION

1. Field of the Invention

The present invention relates to multi-function imaging machines, and, more particularly, to a method and system of faxing through a modem of a multi-function imaging machine via an attached host computer.

2. Description of the Related Art

Computer peripheral equipment provides various desired functionality to an attached computer, such as faxing, scanning, printing, etc. To save space, cost, etc., it has become more common to include multiple functions in a single peripheral device. These are often referred to as multi-function machines (MFM) or all-in-one machines (AIO), which terms are used interchangeably herein. Some of the AIO machines provide the ability to send and receive faxes. When the AIO is attached to a host personal computer (PC), a fax application running on the PC has the ability to send a fax using the fax modem on the AIO. The implementation associated with sending a fax in this manner is commonly referred to as “print-to-fax”. This name is also used in other contexts, for example, for the case where a fax application faxes through the modem on a PC. But as used herein, print-to-fax represents the capability of faxing from the PC through the AIO's modem.

The print-to-fax label is derived from the manner in which the fax interface between the host and the AIO is implemented. In its basic form, the host builds a fax job from electronic documents stored on the PC and/or by scanning documents from the AIO. During the creation of the fax job, a fax driver converts the file and/or scan data into fax data. Via the operating system (OS) in the print processor path, the host printer driver wraps the fax data with additional headers or tags that identify the print job as a fax job. The header contains information about the fax necessary for the AIO to run the fax operation, such as number of pages and destination phone number. These tags also mark the individual pages in the fax job as well as the end of the fax job. The tags are defined as part of the printer command interface between the host and AIO. The host then submits this job as a print job to the AIO through the OS-provided spooler facility that is used for any host print job. When the AIO device receives this “print job” from the host, it analyzes the printer command header and determines that the submitted job is actually a fax job. The AIO processes this job accordingly as a fax job and routes the job through its Fax Scheduler. The Fax Scheduler then manages the integration of the host fax data with the appropriate modem command set (AT commands), inserting AT commands at the appropriate places in the fax job. It then sends the AT-modified fax job to the modem device and manages any negotiation with the destination fax machine as well as the low-level modem transport layer.

There are limitations to the “print-to-fax” solution that constrain its usefulness to the end user:

1. No feedback mechanism to the host. Essentially, print-to-fax operates as a “fax-and-forget” model. Status and fax job completion are not available to the host.

2. No integrated fax logging, otherwise known as fax activity reporting. The host does not have the ability to query the AIO's fax log and integrate AIO log information with host log information.

3. Limitations to the size of the fax job. AIOs are more resource constrained than PCs. This constraint becomes more apparent since the entire fax job must be present on the AIO before the job can be faxed. As a result, the size of the fax job is limited by the available memory resource on the AIO. This constraint limits the user's ability to fax large fax jobs and to fax to multiple recipients even though the host PC has the capacity to support such jobs.

4. No access to host image processing. The fax software on the host PC provides additional image processing capability, such as dithering, that is not present on the AIO.

5. No broadcast capability. There is no facility in the print-to-fax architecture to send a fax to multiple recipients. Instead, the same fax job must be sent to the AIO for each recipient.

6. Inability to negotiate. Since the AIO manages negotiation with the destination modem, the host fax application must format the fax job to the least common denominator in order to ensure that the negotiation is successful. As a result, the host is unable to determine the capabilities of the destination modem, such as the ability to support color faxes, nor can the host make use of other features, such as the use of dithering to diffuse interpolation errors.

7. Contention with the OS spooler. Since a fax job is ultimately routed to the OS spooler, the host PC loses control over when the fax job actually reaches the AIO, based on other spooler work that may be in progress. Similarly, the host has no control over when the AIO actually starts transmission of the fax to the destination modem. Thus, the host must log the fax sending time as the time that the fax job is spooled rather than the actual transmission time to the destination fax machine.

### SUMMARY OF THE INVENTION

The present invention moves significant portions of the fax operation from the AIO to the host PC and defines an associated Host/AIO command interface that allows the host to manage the fax operation at the AT-command level. By relocating this functionality and splitting the host/AIO responsibilities accordingly, a more robust integration of PC and AIO fax capability is delivered and, as a result, enhances the usefulness of print-to-fax to the end user.

The present invention provides a multi-function imaging machine with a modem which can be controlled either by firmware in the multi-function imaging machine or by software and a processing means in an attached computer. The attached computer can query a remote modem attached to the modem in the multi-function machine as to status, printing capabilities, etc. and generate a fax job accordingly for receipt at the remote modem.

The invention comprises, in one form thereof, a method of operating a multi-function imaging machine in combination with a computer, the multi-function imaging machine comprising a printer section, a fax section, a modem associated with the fax section, and a first processing means in communication or coupled with each of the printer section, the fax section and the modem, the computer including a second processing means in communication with the multi-function imaging machine; including the steps of using the first processing means to control the modem during a direct fax from the multi-function imaging machine; and using the second processing means to control the modem during a remote fax from the computer.

The invention comprises, in another form thereof, a method of operating a multi-function imaging machine in combination with a computer, further including the steps of: generating AT commands with the second processing means; transmitting the AT commands from the second processing means to the modem; connecting the modem with a remote modem; transmitting a query from the second processing means to the remote modem; and receiving a response to the query from the remote modem at the second processing means.

In yet another form, in a system comprising a multi-function imaging machine in communication with a host computer, the multi-function imaging machine comprising a printer section, a fax section, a modem associated with said fax section, a first buffer and a first processing means coupled with each of said first buffer, said printer section, said fax section and said modem, the computer comprising a second buffer and second processing means in communication with said second buffer and said multi-function imaging machine, a method of facsimile operation of said system, comprises: using said first processing means to control said modem during a direct fax from said multi-function imaging machine; using said second processing means to control said modem during a remote fax from said computer; generating modem command set data with said second processing means; transmitting said modem command set data from said second processing means to said modem; connecting said modem with a remote modem; transmitting a query from said second processing means to said remote modem; and receiving a response to said query from said remote modem at said second processing means.

With the present invention the modem in the multi-function machine can be controlled by the processing circuit in either the multi-function machine or an attached computer. Also, the host computer or PC can manage the flow of fax data from the host computer to the multi-function imaging machine, thereby reducing buffer memory requirements in the multi-function imaging machine. Further. the computer can be connected to the multi-function imaging machine through a number of different type connections and still provide the desired functionality, such as through a USB connection, network connection, etc. Because portions of the fax operation are moved to the host PC environment the PC's resources are now available to create and manage a fax job. As a result, larger fax jobs, broadcasts and other resource intensive fax operations are now available to the user.

With the invention, the host PC fax application interacts directly with the AIO's modem, allowing the PC fax application to manage the fax operation. The AIO maintains ownership of the modem device. As a result, the PC fax application now has visibility to ongoing fax and modem status as well as the result of the fax operation. This information can be provided to the user. The invention permits the host PC to manage negotiation with the remote/destination modem, and the capabilities of the destination fax machine are accessible to the host PC fax application. The PC fax application can apply enhancements such as color and dithering when the receiving fax machine supports such options, providing a more robust fax solution to the end user

Additionally, unlike existing print-to-fax solutions, the method of the present invention can be easily extended to the fax receive-to-host case as well as to a networked environment.

### BRIEF DESCRIPTION OF THE DRAWINGS

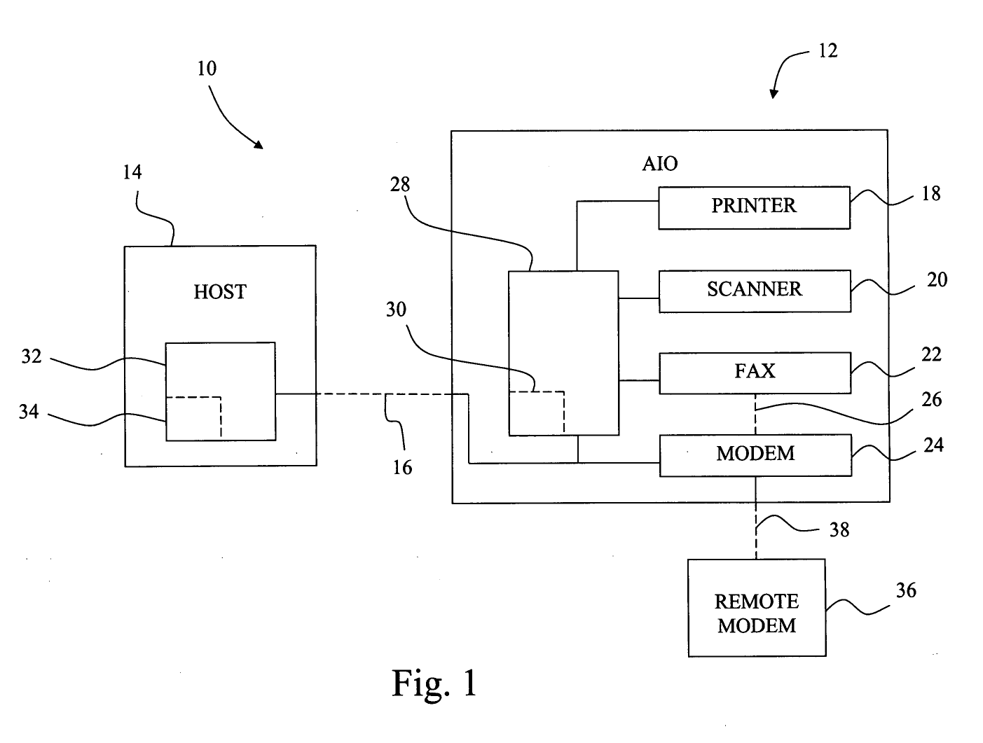

The above-mentioned and other features and advantages of this invention, and the manner of attaining them, will become more apparent and the invention will be better understood by reference to the following description of an embodiment of the invention taken in conjunction with the accompanying drawing, wherein FIG. 1 is a schematic representation of a multi-function imaging system which can be used to carry out an embodiment of a method of the present invention for operating a multi-function imaging machine. The exemplification set out herein illustrates one preferred embodiment of the invention, in one form, and such exemplification is not to be construed as limiting the scope of the invention in any manner.

### DETAILED DESCRIPTION OF THE INVENTION

Referring now to FIG. 1, there is shown an embodiment of a multi-function imaging system 10 which may be used to carry out an embodiment of a method the present invention for operating a multi-function imaging machine 12. Multi-function imaging machine 12 (labeled AIO in FIG. 1) is coupled with a host PC 14 via a suitable connection. In the embodiment shown, multi-function imaging machine 12 is coupled with host 14 via a USB connection 16. However, multi-function imaging machine 12 may be coupled with host PC 14 through a different type connection, depending upon the particular application, such as through a network connection or a wireless connection.

Multi-function imaging machine 12 includes a plurality of functional components, such as a printer section 18, scanner section 20, fax section 22 and modem 24. Modem 24 may be incorporated into fax section 22, or separately electrically coupled with fax section 22 as indicated by dashed line 26. Each of printer 18, scanner 20, fax 22 and modem 24 are coupled with a first electrical processing circuit 28, which may include electrical hardware, firmware and/or software. First electrical processing circuit 28 preferably includes a buffer memory 30 for receiving and temporarily storing image data from host PC 14, such as print image data or fax image data.

Host PC 14 includes a second electrical processing circuit 32, typically a microprocessor based circuit, which carries out usual functions on host PC 14. Second electrical processing circuit 32 is also configured, however, to communicate directly with modem 24 in multi-function imaging machine 12 and manage fax operation of multi-function imaging machine 12 at the AT command level. Second electrical processing circuit 32 is therefore shown in FIG. 1 as being coupled in a manner that allows direct or indirect communication with either first electrical processing circuit 28 or modem 24. To allow a reduced size of buffer memory 30 in first electrical processing circuit 28, second electrical processing circuit 32 likewise includes a buffer memory 34 for storing image data to be transferred to buffer memory 30 in a batch or trickle manner.

Although processing circuits 28 and 32 are described as being an electrical circuit, it should be understood that the functionality provided by these circuits can also be implemented using software or firmware, or a general purpose processor and software or by an ASIC or combinations of the foregoing. Circuits 28 and 32 are in more general terms processing means

Modem 24 is coupled with a destination/remote modem 36 via a suitable connection line 38, such as a telephone line, or a dial-up or broadband connection to a network to which remote modem 36 is connected. Connection line 38 preferably allows two-way communication with remote modem 36, such as transmitting fax data and receiving a query response.

In contrast with the print-to-fax approach described above, the method of the present invention includes the following operational enhancements:

1. The fax job constructed by the host software is no longer a disguised print job. Instead, the host software builds the actual fax data, as before, but without the need for special printer command tags. The host then assumes responsibility for building and managing the AT command stream as well as managing the fax data stream with the AIO modem.

2. The AIO firmware now feeds the AT command stream and/or data directly to the AIO modem device. Unlike the existing print-to-fax solution, where the AIO firmware must look for the fax header and other tags, there is no need for the AIO firmware to examine or otherwise snoop the host data stream. Likewise, the AIO maintains a buffer 30 containing response data from the remote/destination modem 36 and returns this information to host PC 14 without snooping. With this approach, the AIO firmware is isolated from the interaction between the host and the AIO modem. This simplifies firmware implementation within first electrical processing circuit 28 and avoids duplicating command interpretation/construction between the host application software and the AIO. This approach also clearly delineates the host's fax responsibilities and functionality from the AIO's.

3. A robust host/PC-to-AIO command interface is defined and is used to:
a. Lock the fax “device” for exclusive use by the host.
b. Wrap AT command stream and fax data. Firmware unwraps the AT command stream/data and sends it directly to the modem.
c. Retrieve AT reply data from the remote modem. AT replies received from the remote/destination modem are stored in buffer 30 on the AIO. Host PC 14 can periodically query buffer 30 for data and perform the query as many times as necessary to retrieve a completed reply stream. The AIO firmware does not examine the contents of the buffer so that host PC 14 is responsible for determining when a reply stream is complete and interpreting the stream.
d. Check the status of the modem device. Host PC 14 can query whether the AIO modem 24 is busy, for example, in the case where a standalone fax operation is in progress.
e. Manage the flow of AT commands and fax data from host 14 to AIO 12. AIO 12 maintains buffer 30 to cache fax data from host PC 14. The AIO firmware then trickles the fax data to modem 24 at the modem rate of acceptance. This rate is transparent to host PC 14. Host PC 14 can query the current capacity of buffer 30 and intelligently package the size of the next set of fax data to send to the AIO as well as when to send the next packet. This method prevents buffer overruns in AIO 12 and loss of data. The firmware buffer is of sufficient size that modem 24 can be kept sufficiently busy to avoid timeout scenarios with remote/destination fax machine 36.
f. Update and query the AIO's fax log.

4. Responsibility for generating AT command streams and modem negotiation is moved to host PC 14. Modem device and transport management remains on the AIO so that the division of responsibility between host PC 14 and AIO 12 is at the AT command layer. AIO 12 also retains responsibility for any error correction, transparently to host PC 14.

5. Host fax features such as broadcast and image processing remain on host PC 14 and are accessible to the end user through the host application software, providing a more robust overall fax support than the existing print-to-fax solution. The user can also create large fax jobs containing multiple attachments as well as better exploit color faxing since these potentially resource-intensive features are now managed on host PC 14.

The method of the present invention can be extended to host-based receiving of faxes from the AIO. Although this would require additional AIO command interface definition, the basic concept of direct communication with the AIO's modem from the host applies to the receive case.

The method of the present invention is also extendable to network-attached AIOs. In this case, the host continues to construct fax data and manage AT command interaction with the modem. The transport mechanism is then provided through a network protocol such as TCP/IP rather than USB. For certain applications, the fax AIO commands/data are passed over the network to the Ethernet adapter (ENA), which then passes the command stream through to the AIO using the USB connection between the ENA and the AIO.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of operating a multi-function imaging machine in combination with a computer, said multi-function imaging machine comprising a fax section, a modem associated with said fax section and a first processing means in communication with said fax section and said modem and said computer comprising a second processing means in communication with said multi-function imaging machine, comprising the steps of:
using said first processing means to control said modem during a direct fax from said multi-function imaging machine; and
using said second processing means to control said modem during a remote fax from said computer.

2. The method of claim 1, including the steps of:
generating modem command set data with said second processing means; and
transmitting said modem command set data from said second processing means to said modem.

3. The method of claim 2, wherein said modem command set data comprises AT commands.

4. The method of claim 2, including the steps of:
connecting said modem with a remote modem;
transmitting a query from said second processing means to said remote modem; and
receiving via said modem at said second processing means a response to said query from said remote modem.

5. The method of claim 4, wherein said response includes a color printing capability.

6. The method of claim 5, wherein said second processing means generates fax data for receipt at said remote modem, dependent upon said color printing capability response.

7. The method of claim 1, wherein said multi-function imaging machine includes a first buffer in communication with said modem and said computer includes a second buffer, and including the steps of:
buffering fax data received from said second processing means in said second buffer; and
transmitting fax data from said second buffer to said first buffer.

8. The method of claim 7, wherein said fax data is transmitted from said first buffer via said modem to said remote modem in one of a trickle and block manner.

9. The method of claim 1, wherein said computer is coupled with said multi-function imaging machine through one of a USB connection, a wireless connection and a network connection.

10. The method of claim 1, wherein said direct fax comprises a scan-to-fax operation, and said remote fax comprises a data file-to-fax operation.

11. The method of claim 1, wherein each of said first processing means and said second processing means generate a complete fax job for receipt at said modem.

12. The method of claim 11, wherein said complete fax job includes at least one of a header, page break, font type, and color indication.

13. A method of operating a multi-function imaging machine in combination with a computer, said multi-function imaging machine comprising a fax section, a modem associated with said fax section and a first processing means in communication with said fax section and said modem and said computer comprising a second processing means in communication with said multi-function imaging machine, comprising the steps of:
using said first processing means to control said modem during a direct fax from said multi-function imaging machine;
using said second processing means to control said modem during a remote fax from said computer;
generating modem command set data with said second processing means;
transmitting said modem command set data from said second processing means to said modem;
connecting said modem with a remote modem;
transmitting a query from said second processing means to said remote modem; and
receiving a response to said query from said remote modem at said second processing means.

14. The method of claim 13, wherein said response includes a color printing capability.

15. The method of claim 14, wherein said second processing means generates fax data for receipt at said remote modem, dependent upon said color printing capability response.

16. The method of claim 13, wherein said multi-function imaging machine includes a first buffer and said computer includes a second buffer, and including the steps of:
buffering fax data in said second buffer; and
transmitting fax data from said second buffer to said first buffer.

17. The method of claim 16, wherein said fax data is transmitted in one of a trickle and block manner.

18. The method of claim 13, wherein said computer is coupled with said multi-function imaging machine through one of a USB connection, a wireless connection, and a network connection.

19. The method of claim 13, wherein said direct fax comprises a scan-to-fax operation, and said remote fax comprises a data file-to-fax operation.

20. The method of claim 13, wherein each of said first processing means and said second processing means can generate a complete fax job for receipt at said modem.

21. The method of claim 20, wherein said complete fax job can includes at least one of a header, page break, font type, and color indication.

22. The method of claim 13, wherein said second processing means controls said modem during a remote fax from said computer.

23. The method of claim 13, wherein said modem command set data comprises AT commands.

24. In a system comprising a multi-function imaging machine in communication with a host computer, the multi-function imaging machine comprising a printer section, a fax section, a modem associated with said fax section, a first buffer and a first processing means coupled with each of said first buffer, said printer section, said fax section and said modem, the computer comprising a second buffer and second processing means in communication with said second buffer and said multi-function imaging machine, a method of facsimile operation of said system, comprising:
using said first processing means to control said modem during a direct fax from said multi-function imaging machine;
using said second processing means to control said modem during a remote fax from said computer;
generating modem command set data with said second processing means;
transmitting said modem command set data from said second processing means to said modem;
connecting said modem with a remote modem;
transmitting a query from said second processing means to said remote modem; and
receiving a response to said query from said remote modem at said second processing means.

25. The method of claim 24, wherein said response includes a color printing capability.

26. The method of claim 25, wherein said second processing means generates fax data for receipt at said remote modem, dependent upon said color printing capability response.

27. The method of claim 24, during the transmission of a remote fax, further including the steps of:
buffering fax data in said second buffer; and
transmitting fax data from said second buffer to said first buffer.

28. The method of claim 27, wherein said fax data is transmitted in one of a trickle and block manner.

29. The method of claim 24, wherein said computer is coupled with said multi-function imaging machine through one of a USB connection, a wireless connection and a network connection.

30. The method of claim 24, wherein said direct fax comprises a scan-to-fax operation, and said remote fax comprises a data file-to-fax operation.

31. The method of claim 24, wherein each of said first processing means and said second electrical processing means can generate a complete fax job for receipt at said modem.

32. The method of claim 31, wherein said complete fax job can includes at least one of a header, page break, font type, and color indication.

33. The method of claim 24, wherein said second processing means controls said modem during a remote fax from said computer.

34. The method of claim 24, wherein said modem command set data comprises AT commands.

35. A multi-function imaging system, comprising:
a multi-function imaging machine including a printer section, a fax section, a modem associated with said fax section, and a first processing means coupled with each of said printer section, said fax section and said modem;
a computer coupled with said multi-function imaging machine, said computer including a second processing means coupled with said multi-function imaging machine and having direct access to said modem.

36. The multi-function imaging system of claim 35, wherein said computer is coupled with said multi-function imaging machine through one of a USB connection, a wireless connection, and a network connection.

37. The multi-function imaging system of claim 35, wherein said first processing means includes firmware.

38. The multi-function imaging system of claim 35, wherein said modem is incorporated into said fax section.
